(19) United States
(12) Patent Application Publication
(10) Pub. No.: US 2026/0257613 A1
(43) Pub. Date: Sep. 3, 2026

(54) Guide Device for Guiding a Front Light in the Event of a Crash, and Vehicle

(71) Applicant: Bayerische Motoren Werke Aktiengesellschaft, Muenchen (DE)

(72) Inventors: Alexander BOIGER, Mainburg (DE); Katharina SANTNER, Muenchen (DE); Daniel STADLER, Unterschleissheim (DE)

(21) Appl. No.: 18/864,937

(22) PCT Filed: Aug. 25, 2023
(86) PCT No.: PCT/EP2023/073354

§ 371 Date: Nov. 12, 2024

(30) Foreign Application Priority Data
Sep. 14, 2022 (DE) 10 2022 123 494.0

(51) Int. Cl. B60Q 1/04; B60Q 1/00

(52) U.S. Cl. CPC B60Q 1/0495; B60Q 1/0035; B60Q 1/0483

(57) ABSTRACT

A guide apparatus for guiding a vehicle headlamp in the event of a crash has a fastening section for fastening the guide device to the vehicle headlamp and a device which is configured to transmit a force introduced into the vehicle headlamp to a front-end structure in the event of a crash. Further, a vehicle has a front-end structure and a vehicle headlamp, and the guide apparatus is arranged between the vehicle headlamp and the front-end structure. The guide apparatus is fastened to a housing of the vehicle headlamp.

### BACKGROUND AND SUMMARY

The invention relates to a guide apparatus for guiding a vehicle headlight in the case of a crash. Furthermore, the invention relates to a vehicle with a vehicle front end structure and a vehicle headlight, wherein a guide apparatus of this type is arranged between the vehicle headlight and the vehicle front end structure.

Vehicles have a vehicle front end which is formed from a bumper crossmember or a plurality of bumper crossmembers and longitudinal beams made from metal. The bumper crossmember and the longitudinal beams are connected to one another by way of struts, in order to form a rigid vehicle front end structure for the case of a crash. The front headlights are attached to the vehicle front end structure. A vehicle front end structure of this type is known from DE 198 56 350 A1.

Furthermore, a fastening element for fastening a headlight to a longitudinal beam in a vehicle front end of a motor vehicle is apparent from DE 10 2018 208 194 A1. The fastening element has a connecting portion which extends in a longitudinal direction, and a supporting arm which extends in a direction transversely with respect to the connecting portion, wherein the connecting portion extends from a rear region with a first contact surface for bearing against a first surface of the longitudinal beam as far as a front region with an attaching portion for fastening the headlight, and wherein a second contact surface for bearing against a second surface, oriented so as to deviate from the first surface, of the longitudinal beam is configured on the supporting arm.

In the case of a crash, the known vehicle front end structures have the disadvantage that the front headlight intrudes and irreparably damages the supporting beam of the wheel arch which is fixed to the vehicle body. Within the context of the initial insurance classification, this results in a higher classification class, which leads to increased insurance costs.

The present invention is based on the object of providing a guide apparatus and a vehicle which, in the case of a crash, prevents damage of the supporting beam of the wheel arch or limits it in such a way that no irreparable structural damage occurs.

In order to achieve the object, a guide apparatus and a vehicle according to the claimed invention are proposed.

In accordance with a first aspect of the invention, a guide apparatus for guiding a vehicle headlight in the case of a crash is proposed. The guide apparatus has a fastening portion for fastening the guide apparatus to the vehicle headlight, and a guide device which is configured to transfer a force, introduced into the vehicle headlight, to a vehicle front end structure in the case of a crash.

The guide apparatus prevents the penetration of the vehicle headlight through the vehicle front end structure, by the guide apparatus dissipating the force, introduced into the vehicle headlight in the case of a crash, over the vehicle front end structure. As a result, the vehicle front end structure, in particular a supporting beam of a wheel arch, remains undamaged.

In the present case, the vehicle headlight is a front light which has a housing which is connected to the vehicle front end structure, and has at least one lamp which is arranged in the housing.

The fastening portion of the guide apparatus is advantageously connected to a housing of the vehicle headlight.

The vehicle front end structure advantageously has at least one bumper crossmember and longitudinal beams which adjoin it, wherein the bumper crossmember is connected to the longitudinal beams via a support/lock structure.

In one advantageous refinement, the fastening portion is configured as a plate which has at least one fastening device for fastening the guide apparatus to the vehicle headlight. The fastening device can have at least one bore for guiding through a fastening element which is connected to the vehicle headlight, in particular the housing of the vehicle headlight. The plate advantageously has a straight portion with the fastening device and a curved portion which adjoins the guide device, in particular a curved connecting portion of the guide device.

In one advantageous refinement, the guide device transmits the force, introduced into the vehicle headlight, to the vehicle front end structure by way of deformation work in the case of a crash. In this way, the guide device dissipates the force and energy, introduced to the vehicle headlight in the case of a crash, by way of a deformation of the guide device. In addition, the deformation ensures a controlled movement of the vehicle headlight in the case of a crash.

In one advantageous refinement, the guide device has a guide portion with a claw portion which claws and/or cuts into the vehicle headlight in the case of a crash, and a contact portion which bears against the vehicle front end structure in the case of a crash. Therefore, in the case of a crash, the guide device is supported via the contact portion on the vehicle front end structure, in particular on the support/lock structure, and at the same time its claw portion claws and/or cuts into the vehicle headlight. As a result, the penetration of the vehicle headlight through the vehicle front end is prevented by the introduced force being dissipated via the support/lock structure, and the support/lock structure remaining undamaged The claw portion advantageously claws and/or cuts into a housing of the vehicle headlight. In one advantageous refinement, the claw portion is of sharp-edged configuration for clawing and/or for cutting purposes. The guide device advantageously has two claw portions which lie opposite one another. The contact portion advantageously runs in the vehicle vertical direction, and the claw portion runs in the vehicle transverse direction.

In one advantageous refinement, the claw portion is configured as a conically tapering projection which is of sharp-edged configuration at its free end. As a result, the conically tapering projection claws and/or cuts into the vehicle headlight, in particular into the housing of the vehicle headlight. In one advantageous refinement, the guide device has two conically tapering projections which lie opposite one another and are of sharp-edged configuration at their free ends.

In one advantageous refinement, the guide device has a curved connecting portion which connects the guide portion and the fastening portion to one another. In the case of a crash, the curved connecting portion ensures spreading of the guide apparatus, and therefore that, in the case of a crash, the vehicle headlight is pressed to the outside, that is to say away from the vehicle.

In one advantageous refinement, the curved portion has an S-curve. The S-curve or the S-profile is deformed during the case of a crash, with the result that the force which is introduced into the vehicle headlight is dissipated. In addition, the vehicle headlight is pressed outward by way of the deforming S-profile, with the result that the vehicle headlight does not penetrate the vehicle front end structure.

In one advantageous refinement, the guide portion is configured as a tub-shaped plate. The tub-shaped plate is connected via the curved connecting portion to the fastening portion.

In one advantageous refinement, a portion of a peripheral edge of the tub-shaped plate forms the contact portion, wherein the conically tapering projection protrudes from the peripheral edge. The two conically tapering projections which lie opposite one another advantageously protrude from the edge portion. That portion of the peripheral edge which forms the contact portion advantageously faces a support/lock structure. Furthermore, the curved connecting portion advantageously merges into the peripheral edge which forms the contact portion. Furthermore, the conically tapering projections advantageously protrude perpendicularly in the vehicle transverse direction from the peripheral edge. Furthermore, the projections advantageously protrude from the peripheral edge at a free end, lying opposite the contact portion, of the tub-shaped plate.

In one advantageous refinement, the guide apparatus is a single-part sheet metal part which is produced by way of bending, punching and/or deep drawing. The sheet metal part advantageously has a thickness between 1.5 mm and 4 mm, in particular 2.5 mm.

In accordance with a further aspect of the invention, a vehicle with a vehicle front end structure and a vehicle headlight is proposed, wherein a guide apparatus as described herein arranged between the vehicle headlight and the vehicle front end structure.

In the following text, a vehicle, a guide apparatus and further features and advantages will be described in greater detail on the basis of one exemplary embodiment which is shown diagrammatically in the figures.

### BRIEF DESCRIPTION OF THE DRAWINGS

FIG. 1 shows a vehicle with a vehicle front end structure and a vehicle headlight.

FIG. 2 shows a perspective illustration of a guide apparatus.

FIG. 3 shows a second perspective illustration of the guide apparatus.

FIG. 4 shows a plan view of the guide apparatus which is arranged between the vehicle front end structure and the vehicle headlight.

FIG. 5 shows a perspective illustration of the fastening of the guide apparatus to a housing of the vehicle headlight.

FIG. 6 shows a diagrammatic illustration of the guide apparatus, the vehicle headlight and the vehicle front end structure before a crash.

FIG. 7 shows a diagrammatic illustration of the guide apparatus, the vehicle headlight and the vehicle front end structure after a crash.

### DETAILED DESCRIPTION OF THE DRAWINGS

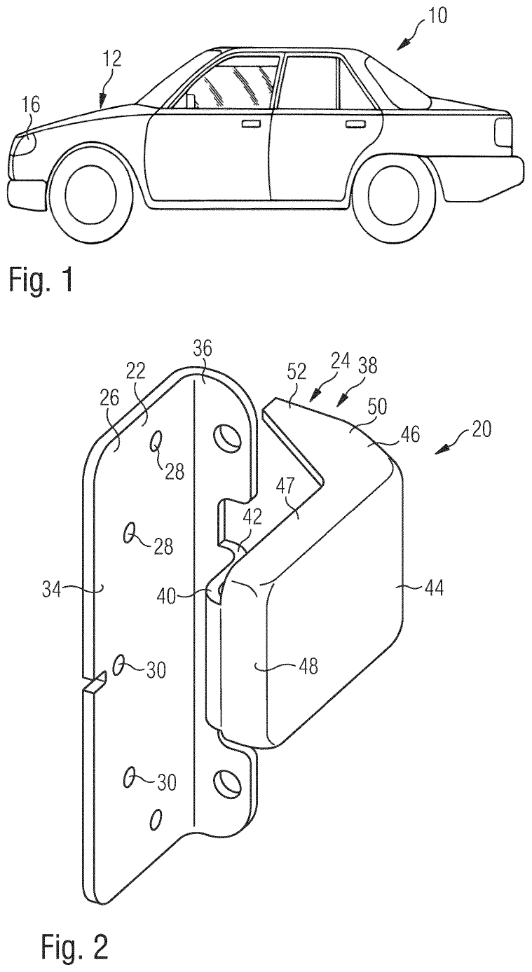

FIG. 1 shows a vehicle 10 which has a vehicle front end structure 12 with a support/lock structure 14 (shown in FIG. 4) and a vehicle headlight 16 which is arranged on the vehicle front end structure 12.

As can be seen in FIG. 4, a guide apparatus 20 is provided between the vehicle headlight 16 and the vehicle front end structure 12, in particular the support/lock structure 14, which guide apparatus 20 prevents the penetration of the vehicle headlight 16 through the vehicle front end structure 12 in the case of a crash, as will be explained in even greater detail in the following text.

The guide apparatus 20 is a single-part sheet metal part which is produced by way of bending, punching and/or deep drawing. The sheet metal part has a thickness between 1.5 mm and 4 mm, in particular 2.5 mm.

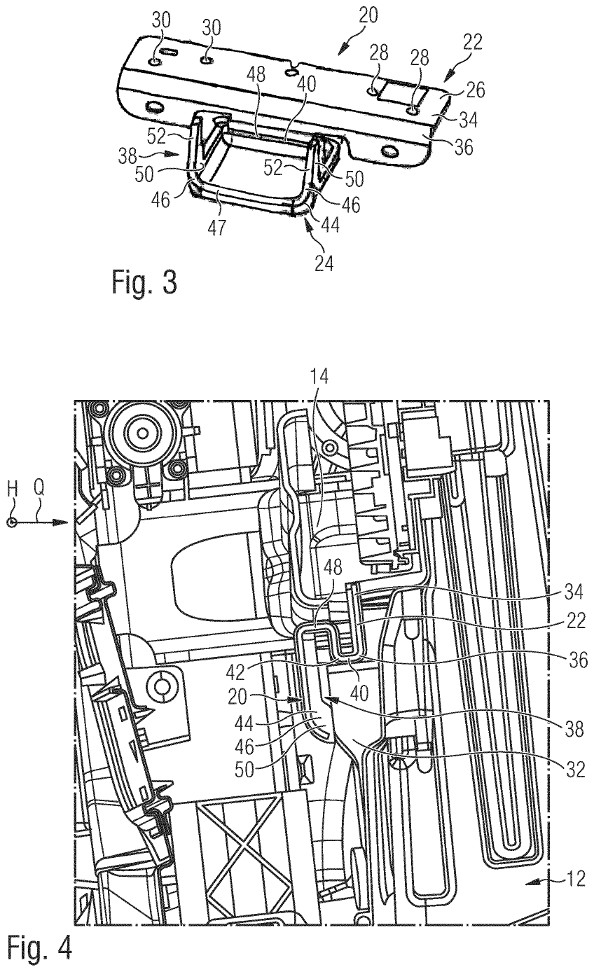

According to FIGS. 2 and 3, the guide apparatus 20 has a fastening portion 22 for fastening the guide apparatus 20 to the vehicle headlight 16, and a guide device 24.

The fastening portion 22 is configured as a plate 26 which has a straight portion 34 and a curved portion 36. The curved portion 36 is adjoined by the guide device 24.

As shown in FIG. 5, the fastening portion 22 is connected to a housing 32 of the vehicle headlight 16. To this end, fastening devices 28 in the form of openings 30 for guiding through fasteners (not shown) which can be screwed into the housing 32 of the vehicle headlight 16 are made in the straight portion 34.

The guide device 24 has a guide portion 38 and a curved connecting portion 40 which connects the guide portion 38 to the fastening portion 22.

The curved portion 36 merges into the curved connecting portion 40, wherein the curved connecting portion 40 forms an S-profile or an S-curve 42, as can be seen in FIGS. 2 and 4, in particular.

The guide portion 38 is configured as a tub-shaped plate 44, and has two claw portions 46 and a contact portion 48.

The claw portions 46 are configured as conically tapering projections 50 which protrude from a peripheral edge 47 of the tub-shaped plate 44 in a vehicle transverse axis Q, as can be seen in FIGS. 2 and 3. The conically tapering projections 50 are of sharp-edged configuration at their free ends 52.

The curved connecting portion 40 merges into the contact portion 48 which is formed from a portion of the peripheral edge 47. The contact portion 48 runs in a vehicle vertical axis H, as can be seen, in particular, in FIG. 5, and faces the support/lock structure 18, as can be seen in FIGS. 4, 6 and 7.

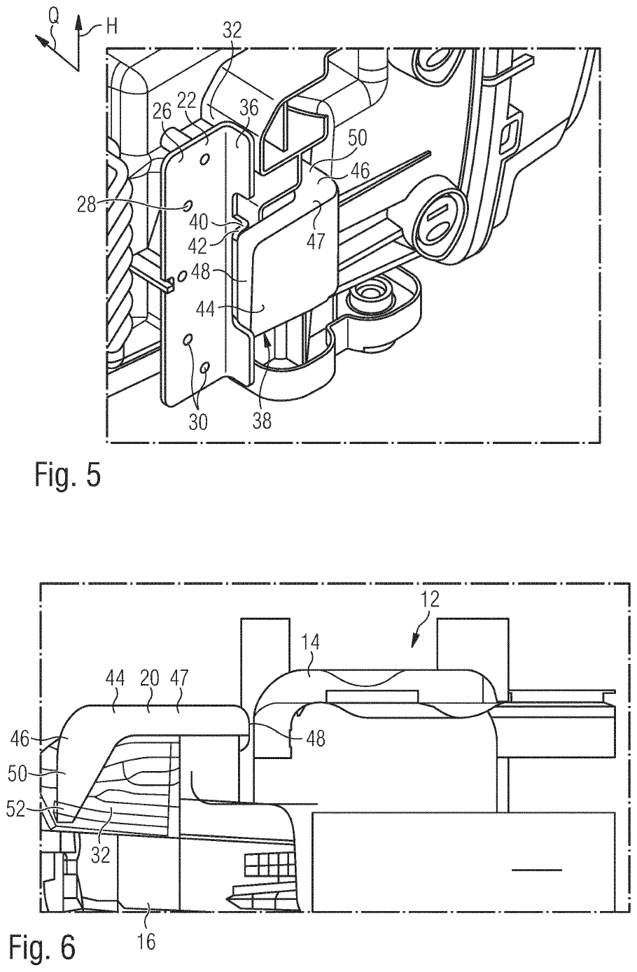

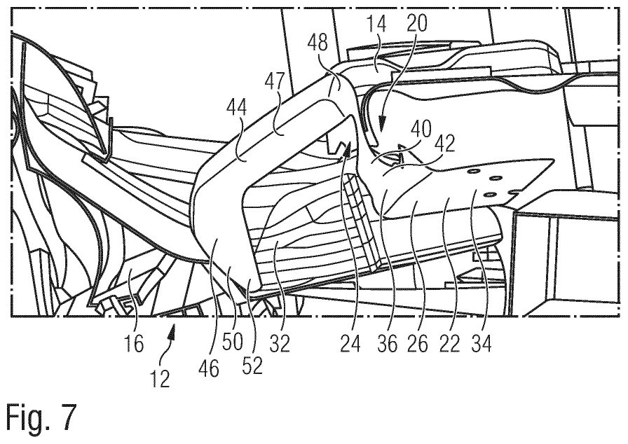

As can be seen from a combination of FIGS. 6 and 7, the sharp-edged free end 52 of the conically tapering projections 50 claws and/or cuts into the housing 32 in the case of a crash, and at the same time the contact portion 48 bears against the support/lock structure 18, and the S-curve 42 is deformed. As a result, in the case of a crash, the guide device 24 transmits the force, introduced into the vehicle headlight 18, to the support/lock structure 18, and thus prevents the penetration of the vehicle headlight 16 through the vehicle front end structure 14, as shown in FIG. 7. As a consequence, the support/lock structure 18 remains undamaged.

The guide apparatus 20 prevents a penetration of the vehicle headlight 16 through the vehicle front end structure 12, by the guide apparatus 20 dissipating the force, introduced into the vehicle headlight 16 in the case of a crash, over the vehicle front end structure 12. As a result, the vehicle front end structure 12, in particular a supporting beam of a wheel arch, remains undamaged.

### LIST OF DESIGNATIONS

10 Vehicle
12 Vehicle front end structure
14 Support/lock structure
16 Vehicle headlight
20 Guide apparatus
22 Fastening portion
24 Guide device
26 Plate
28 Fastening device
30 Opening
32 Housing
34 Straight portion
36 Bent portion
38 Guide portion
40 Bent connecting portion
42 S-curve
44 Tub-shaped plate
46 Claw portion
47 Peripheral edge
48 Contact portion
50 Conically tapering projection
52 Free end
Q Vehicle transverse axis
H Vehicle vertical axis

1.-10. (canceled)

11. A guide apparatus for guiding a vehicle headlight in a case of a crash, the guide apparatus comprising:
a fastening portion for fastening the guide apparatus to the vehicle headlight, and
a guide device which is configured to transmit a force, introduced into the vehicle headlight, to a vehicle front end structure in the case of the crash.

12. The guide apparatus according to claim 11, wherein the guide device transmits the force, introduced into the vehicle headlight, to the vehicle front end structure by way of deformation work in the case of the crash.

13. The guide apparatus according to claim 11, wherein the guide device has a guide portion with a claw portion which claws and/or cuts into the vehicle headlight in the case of the crash, and a contact portion which bears against the vehicle front end structure in the case of the crash.

14. The guide apparatus according to claim 13, wherein the claw portion is configured as at least one conically tapering projection which is of sharp-edged configuration at its free end.

15. The guide apparatus according to claim 11, wherein the guide device has a curved connecting portion which connects the guide portion and the fastening portion to one another.

16. The guide apparatus according to claim 15, wherein the curved connecting portion has an S-curve.

17. The guide apparatus according to claim 14, wherein the guide portion is configured as a tub-shaped plate.

18. The guide apparatus according to claim 17, wherein a portion of a peripheral edge of the tub-shaped plate forms the contact portion, and the at least one conically tapering projection protrudes from the peripheral edge.

19. The guide apparatus according to claim 11, wherein the guide apparatus is a single-part sheet metal part which is produced by way of bending, punching and/or deep drawing.

20. A vehicle comprising a vehicle front end structure and a vehicle headlight, wherein the guide apparatus according to claim 11 is arranged between the vehicle headlight and the vehicle front end structure.
